(19) United States
(12) Patent Application Publication
(10) Pub. No.: US 2010/0104143 A1
(43) Pub. Date: Apr. 29, 2010

(54) Method and System for Processing Operator Log Documents

(76) Inventors: Ivan E. Paez, New Berlin, WI (US); John F. Van Nortwick, Hartland, WI (US); Gregory J. Lofy, Deerfield Beach, FL (US)

Correspondence Address: WHYTE HIRSCHBOECK DUDEK S C;INTELLECTUAL PROPERTY DEPARTMENT, 555 EAST WELLS STREET, SUITE 1900, MILWAUKEE, WI, 53202, US

(21) Appl. No.: 12/582,118

(22) Filed: Oct. 20, 2009

Related U.S. Application Data
(60) Provisional application No. 61/106,750, filed on Oct. 20, 2008.

(51) Int. Cl. G06K 9/00; H04N 1/04; G06K 9/34

(52) U.S. Cl. 382/113; 358/474; 382/176

(57) ABSTRACT

Driver reporting documents are managed by a method comprising scanning a physical driver log sheet including an analog graph to obtain an electronic image data file which is stored on a system. A unique identifier is associated to the electronic image data file. The electronic image data file is processed to capture data regarding reported activity, wherein analog grid information is extracted as digital information and to capture data regarding non-grid activity. The data regarding reported activity is processed to determine compliance with activity standards and a report on compliance with activity standards is generated. A system for implementing this method is also disclosed.

### CROSS REFERENCE TO RELATED APPLICATION

This application claims the benefit under 35 USC §119(e) of U.S. Provisional Application No. 61/106,750, filed Oct. 20, 2008, the teachings and disclosure of which are incorporated herein by reference.

### BACKGROUND OF THE INVENTION

One significant safety factor in the transportation industry is the physical condition of the driver or operator. A tired driver is more likely to be inattentive or slower to react, thereby putting himself, his equipment, cargo, passengers, and nearby third parties at increased risk. In order to reduce this risk, laws and regulations have been passed that strictly regulate maximum driving and on duty time as well as minimum rest times. Further, regulations exist requiring the use of driver log documents (operator or driver logs or log sheets), and regulating the way these documents are to be created or maintained.

In the U.S., such regulations are currently outlined in 49 CFR Part 395.8., entitled “Driver's record of duty status”. In particular, a driver log must include a graph for a driver to indicate the time spent by the driver in various categories. Currently, this graph is for a 24 hour period and includes four different categories: driving, on duty but not driving, sleeping, and off duty. This document must be prepared on a daily basis and contains other information fields to be filled in including date, total miles driven, truck or tractor and trailer number, name of driver, driver's signature/certification, time that the 24 hour log started, main office address of the employer, any remarks, name of the co-driver, etc.

Furthermore, a transportation company is obligated to ensure that all of their drivers comply with the regulations. Accordingly, the transportation company must review, store, and report on the drivers' log documents. Failure to follow the regulations can result in a downgrade in a carrier's safety rating, fines or even criminal prosecution (395.8.e).

The transportation company's duties to ensure compliance through review of the individual log documents can be very onerous for larger corporations. While some attempts have been made to automate the driver log review process, a number of difficulties still remain. Among the problems are that most driver logs are recorded by hand and may be hard to read. Further, a wide variety of formats for the driver log documents are currently used in the industry.

### SUMMARY OF THE INVENTION

An important feature of the current invention is an automated log review process that has improved driver log analyzing capabilities and allows for many driver log documents regardless of their format or size to be quickly and efficiently processed.

In one embodiment, the invention is a data processing system for managing driver log sheets. The system includes a scanner for converting physical driver log sheets into electronic image files, wherein each driver log sheet corresponds to a respective one of the electronic image files, and one or more computers each having a processor and a database for storing data for receiving the electronic image files and operating to associate a unique identifier to each electronic image file, process each electronic image file to capture data regarding reported activity in each of a plurality of time frames of an analog graph and generate a respective reported activity data file, process the reported activity data file for each electronic image to determine compliance with activity standards and generate a report on the compliance with activity standards.

In another embodiment, the invention is a method performed by a computer for managing driver log sheets for reporting driver time, the method including scanning physical driver log sheets, each including an analog graph with reported driver activity for each of a plurality of time periods, to obtain electronic image files, wherein each driver log sheet corresponds to a respective one of the electronic image files. The method further includes storing the electronic image files on a storage medium, associating a unique identifier to each of the electronic image files, and processing the electronic image files to extract from each file respective captured graph data indicative of reported driver activity for each of the time periods, processing the captured graph data indicative of reported driver activity to determine compliance with driver activity standards; and generating a report on compliance with driver activity standards.

### BRIEF DESCRIPTION OF THE DRAWINGS

Preferred embodiments of the invention are described below with reference to the following accompanying drawings, which are for illustrative purposes only. Throughout the following views, reference numbers will be used in the drawings, and the same reference numbers will be used throughout the several views and in the description to indicate same or like parts or steps.

FIG. 1 is a flowchart showing an overview of an exemplary method for processing driver logs in accordance with at least one aspect of the invention;

FIG. 2 is a flowchart of process 1 of FIG. 1 showing a scanning process for paper log sheets;

FIG. 3 is a flowchart of process 2 of FIG. 1 showing a process for converting the image file format from a zip to a .tiff file;

FIG. 4 is a flowchart of process 3a of FIG. 1 showing a process for reading bar codes;

FIG. 5 is a flowchart of process 3b of FIG. 1 showing a process for uniquely naming and storing the document electronic files;

FIG. 6 is a flowchart of process 4 of FIG. 1 showing a process for packing and sending images for data capture;

FIG. 7 is a flowchart of process 5a of FIG. 1, showing preprocessing steps including a form identification step;

FIG. 8 is a flowchart of process 5b of FIG. 1, showing a data capture process for an identified form;

FIG. 9 is a flowchart of step 561 of process 5b of FIG. 8, showing the process for capturing data from the driver log graph;

FIG. 10 is a flowchart of process 6 of FIG. 1, showing the process for importing CSV strings into a visible (web accessible) database;

FIG. 11 is a flowchart of process 7 of FIG. 1, showing the process for validating the logs;

FIG. 12 is an exemplary driver log sheet; and

FIG. 13 is an exemplary system for processing operator log documents.

### DESCRIPTION OF THE INVENTION

In the following detailed description, references made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process step changes may be made without departing from the spirit and scope of the present invention.

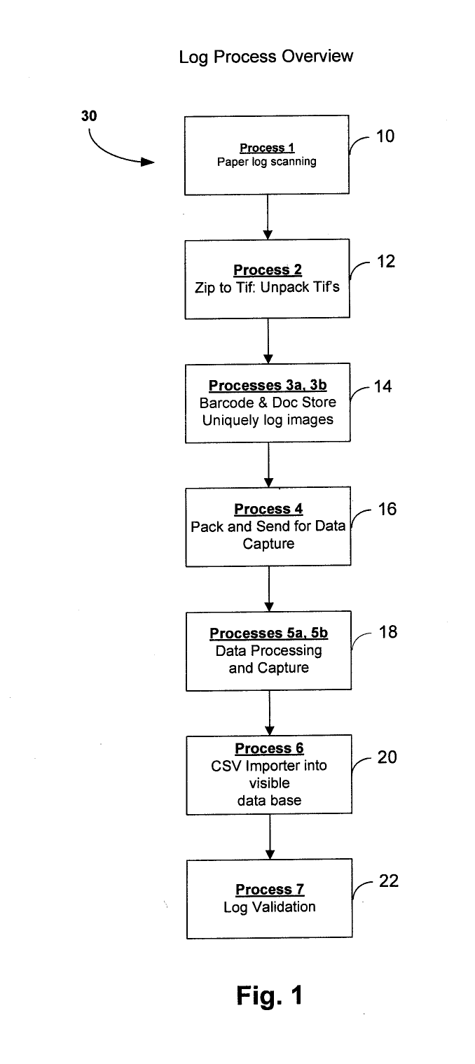

FIG. 1 illustrates a general overview of an exemplary log processing method 30 which includes processes 1-7. The method is described in terms of scanning paper driver log sheets, and processing electronic image versions of these log documents, but any similar reporting documents are included within the scope of the invention. Basically, the method operates to process the electronic image files of the log sheets to extract relevant filled in text information and graphical information from the image file. Additionally, corresponding reports can be generated reporting among other things, compliance with various rules, such as rules relating to limits on driving activity. The associated image files and the corresponding reports are maintained on one or more databases and are accessible by a client over a network such as the Internet. Although the processes are shown in a specified order, the processes need not be performed in the order illustrated. For example, all or portions of processes 5a and 5b can be performed either before or after process 4. Further, not all of the steps shown are necessary.

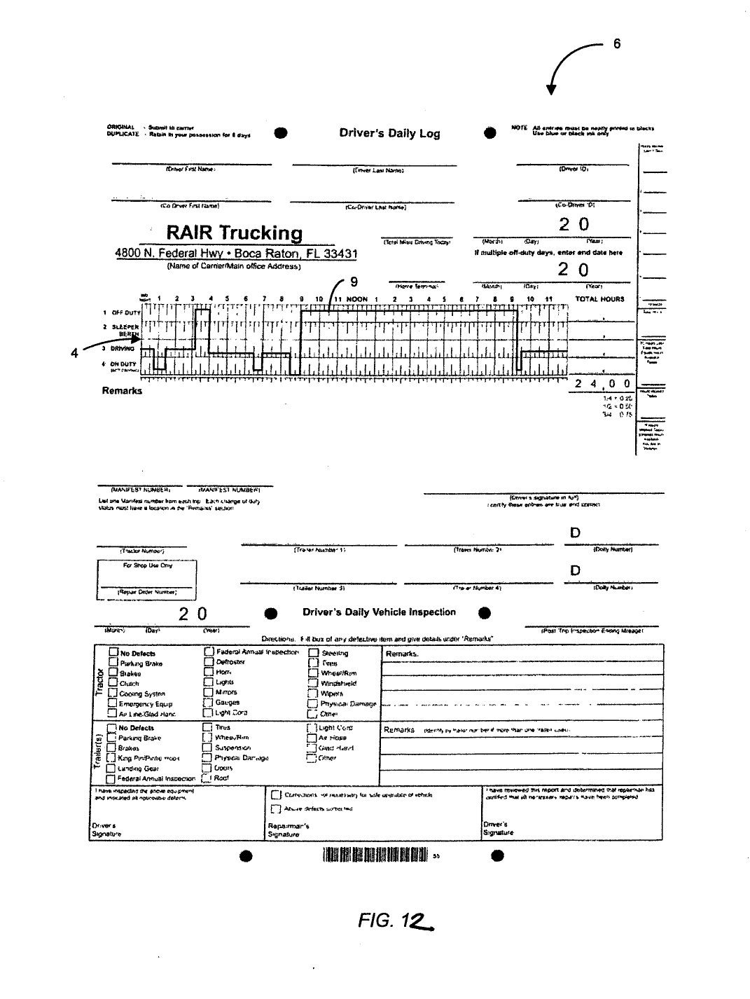

An exemplary driver log sheet 6 is shown in FIG. 12, and includes an exemplary analog grid or graph 4 and other information fields which are typically filled in by a driver or operator. Driver log sheets come in various types or forms, and this method can be used in conjunction with the different types or forms of these log sheets, even though the location of the various information fields and format of the graph can vary among the different forms. In particular, shown is a 24 hour graph divided into periods representing a specific quarter hour period (i.e., 96 quarter hour periods in a 24 hour day). The graph is also divided into a number of rows, such as four, with each row representing a category or activity performed by an operator, such as driving, on-duty but not driving, off-duty, and sleeping. The graph 4 of the driver log sheet 6 is filled out by a driver with a line, such as line 9, to designate the engaged activity of the driver for each quarter hour interval throughout a 24 hour day.

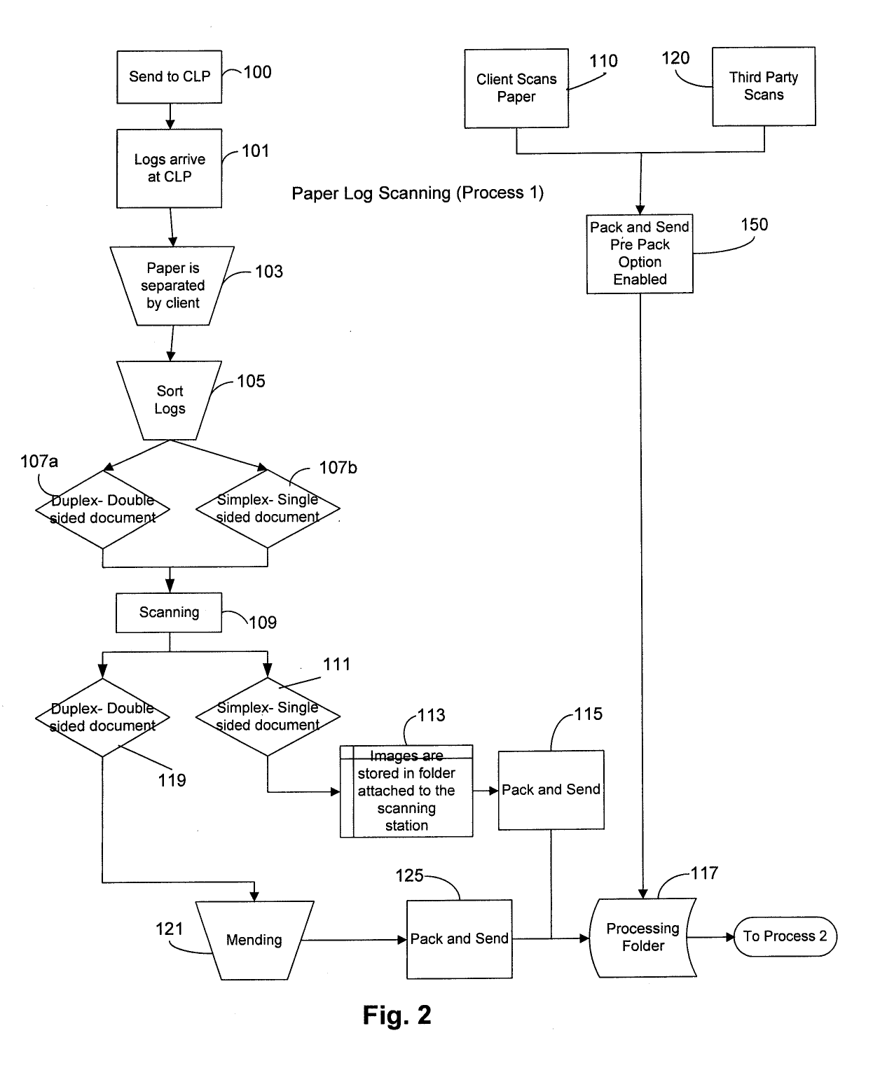

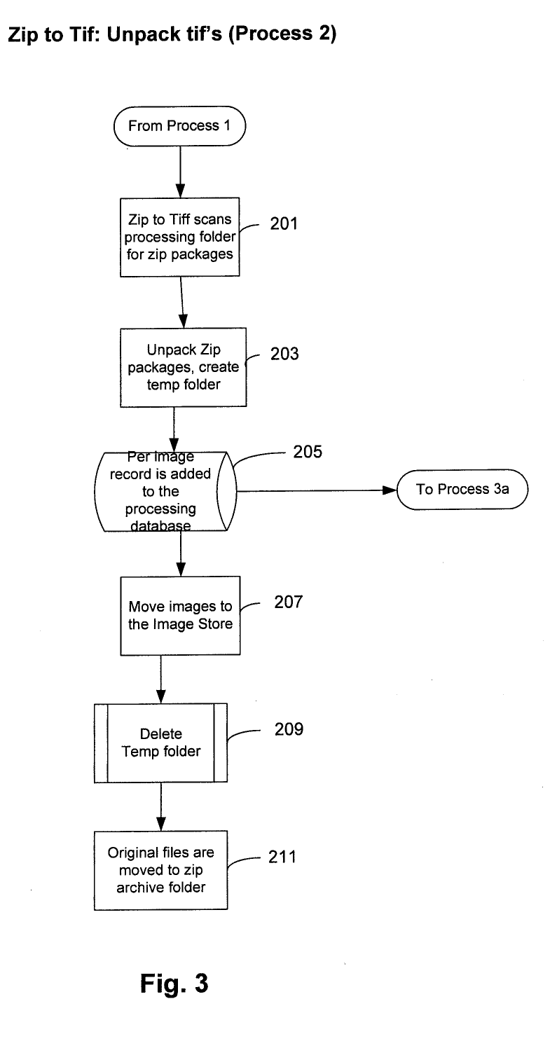

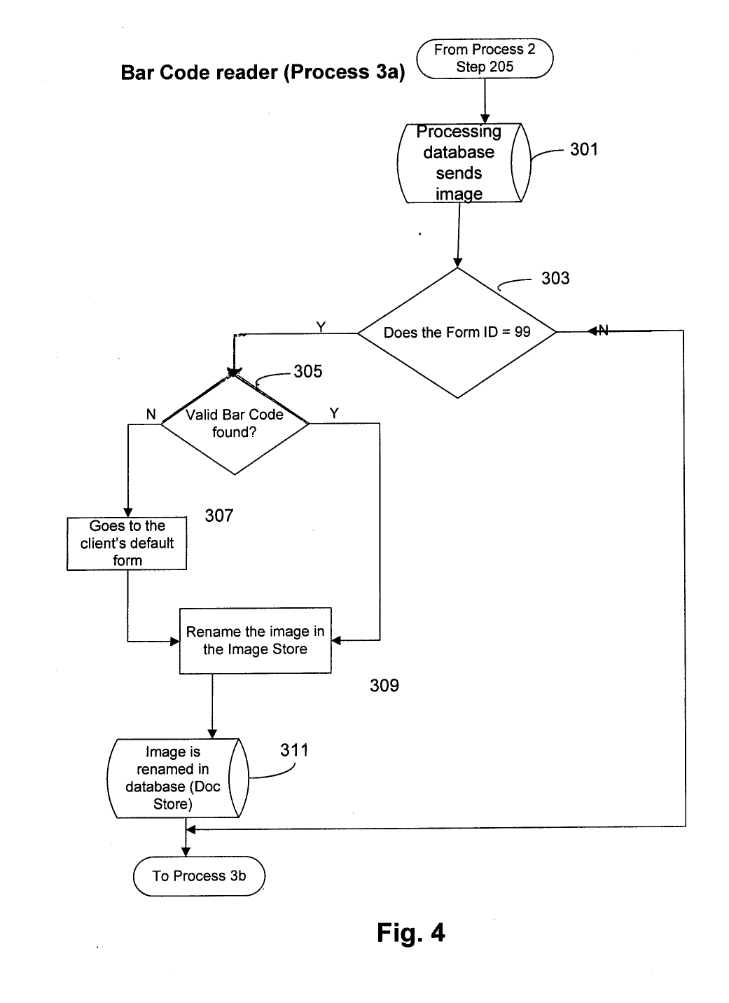

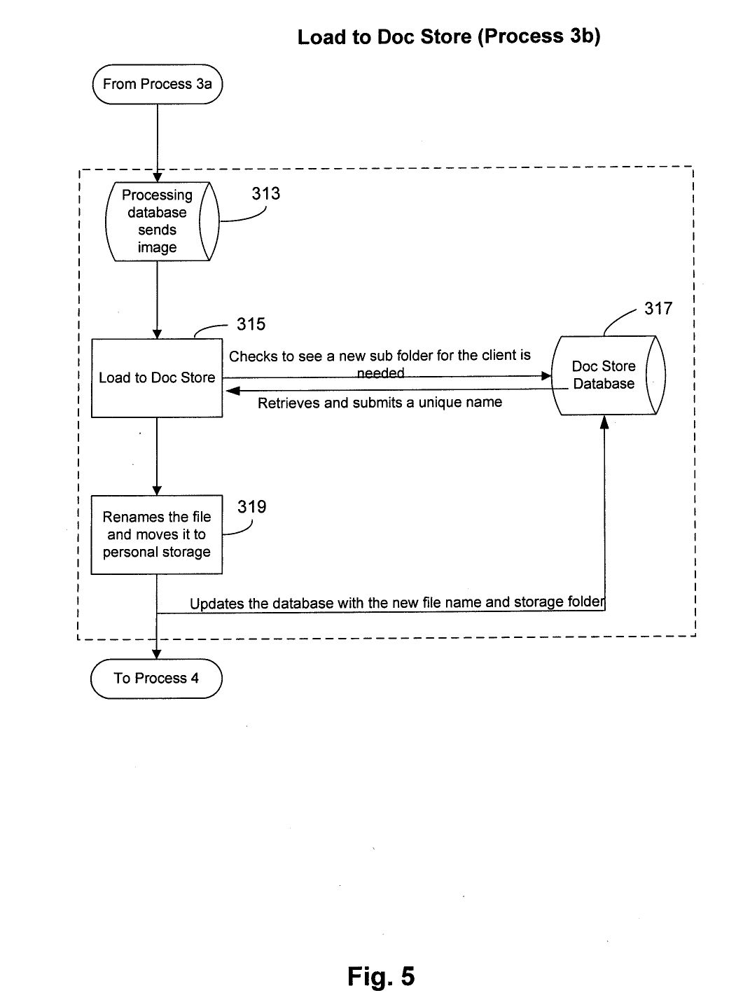

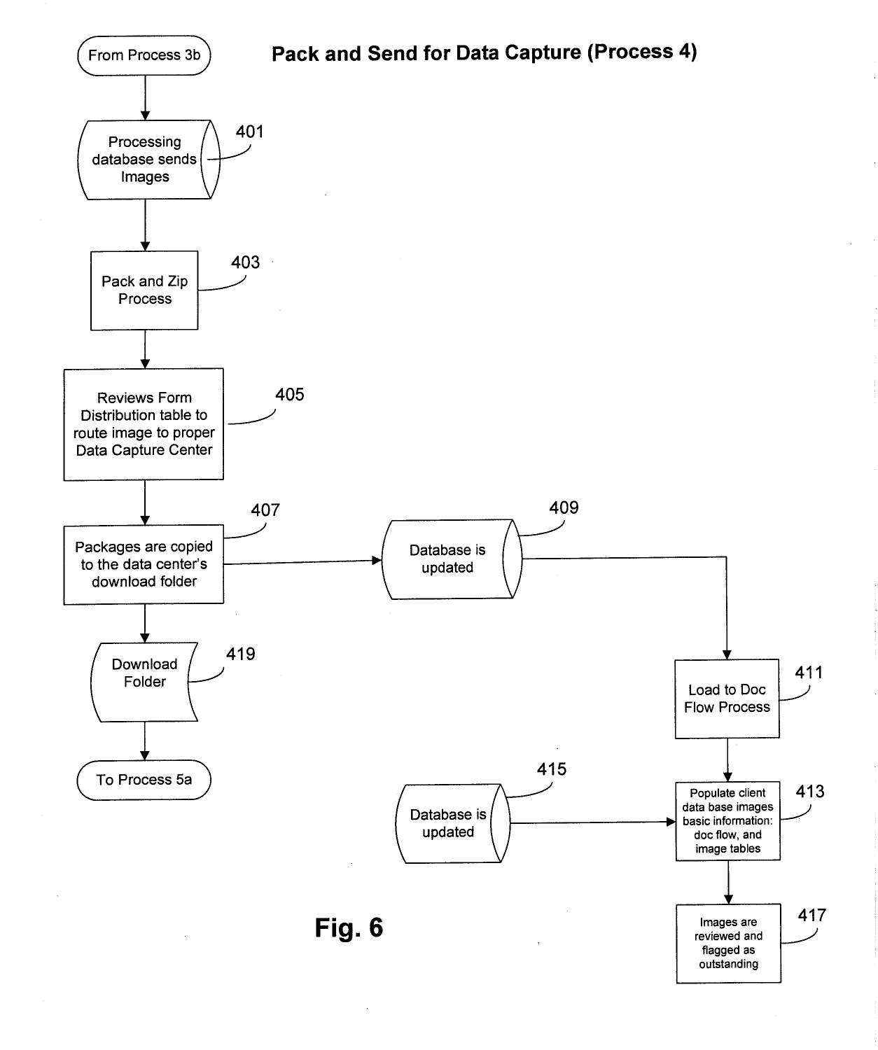

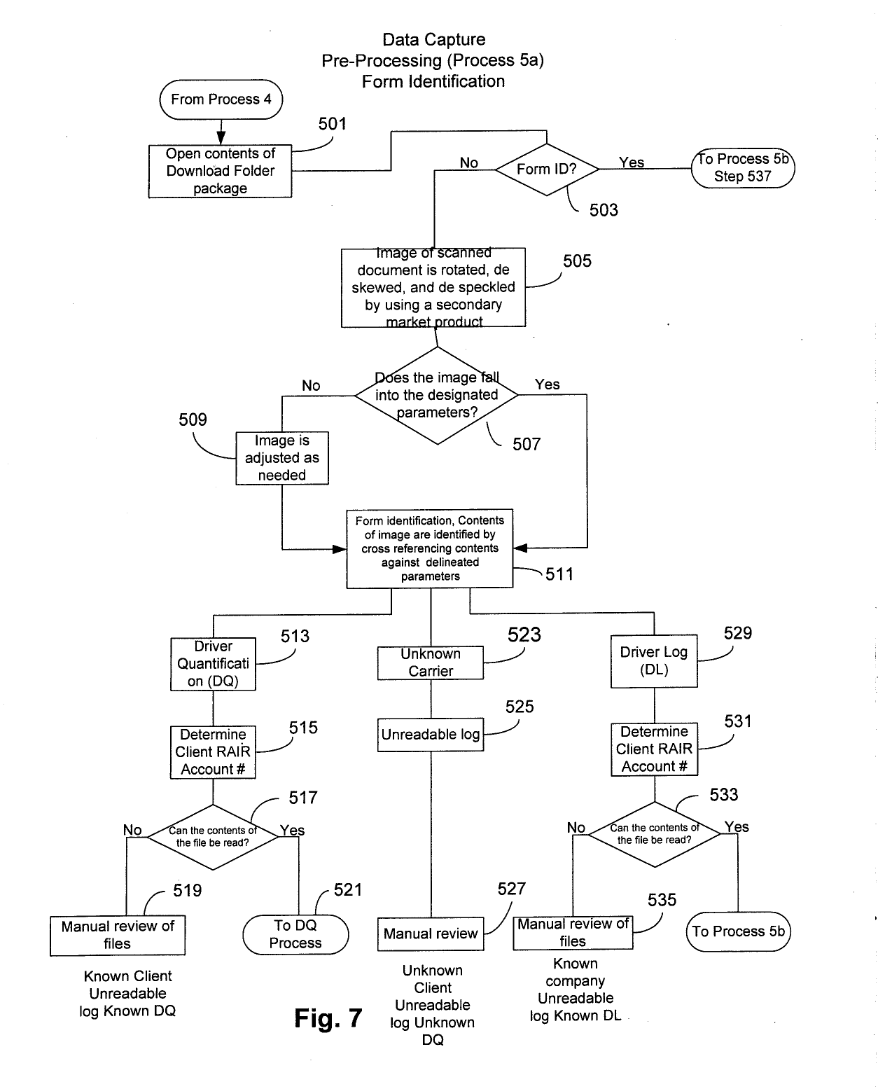

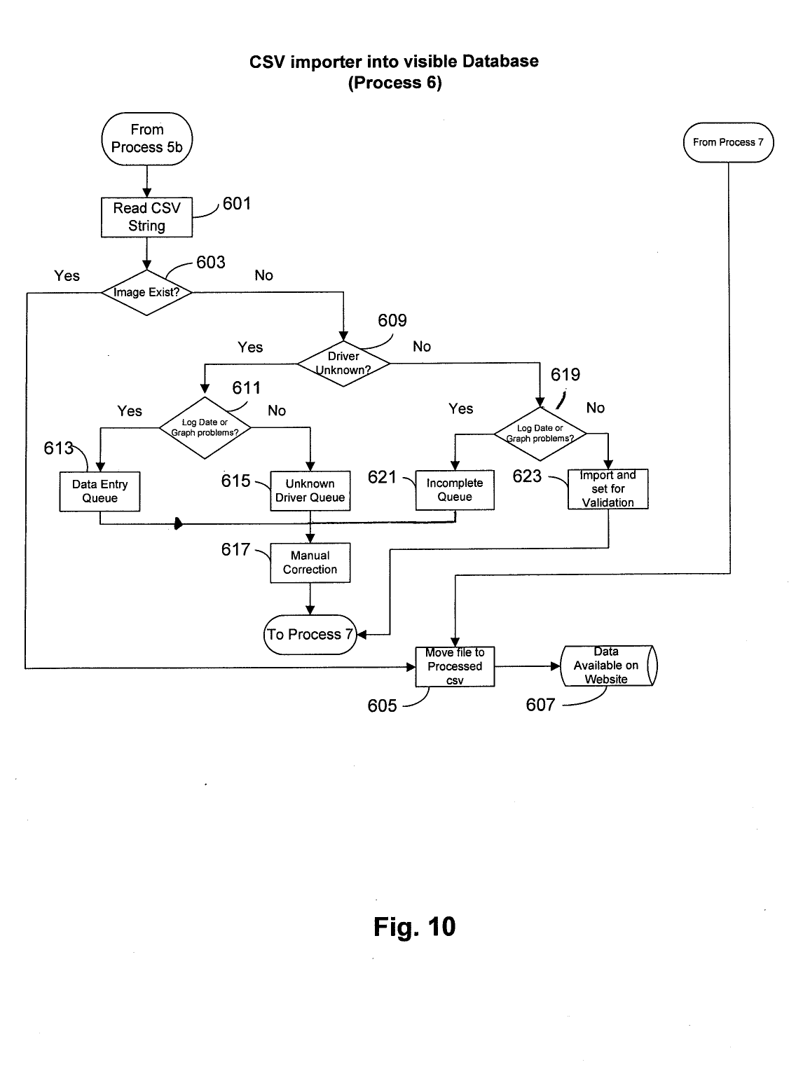

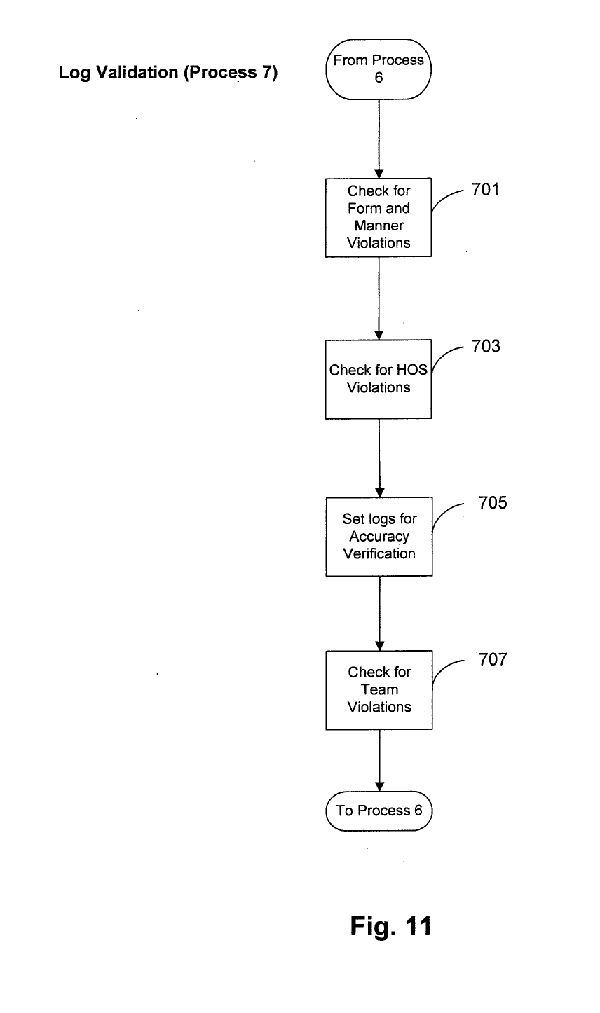

As a general overview, process 1 (see FIG. 2) involves paper log scanning, wherein each of a plurality of log sheets are scanned and stored as a respective electronic image file, preferably in a tagged image file format (TIFF), also called a .tiff or .tif file. Further, this process involves zipping (compressing) multiple .tiff image files to form a ZIP package and sending it to a processing folder of a computer. Process 2 (see FIG. 3) occurs at the processing folder and involves unpacking the .tiff image files from the sent ZIP package. Next, processes 3a and 3b (see FIGS. 4-5) involve reading any existing barcodes from the image files to identify the form corresponding to each image file, and uniquely logging each image file representing a driver log sheet. Process 4 (see FIG. 6) involves packing and sending the image files to an appropriate data center for data capture. Processes 5a and 5b (see FIGS. 7-9) involve identifying an appropriate form corresponding to a log sheet being processed (if not already identified) using for example optical character recognition, and capturing the data from the image files, including the non-grid text data and the data from the graph. Process 6 (see FIG. 10) involves importing CSV (comma separated variable) strings into visible (web accessible) databases. Finally, process 7 (see FIG. 11) involves validating the electronic logs to generate corresponding reports.

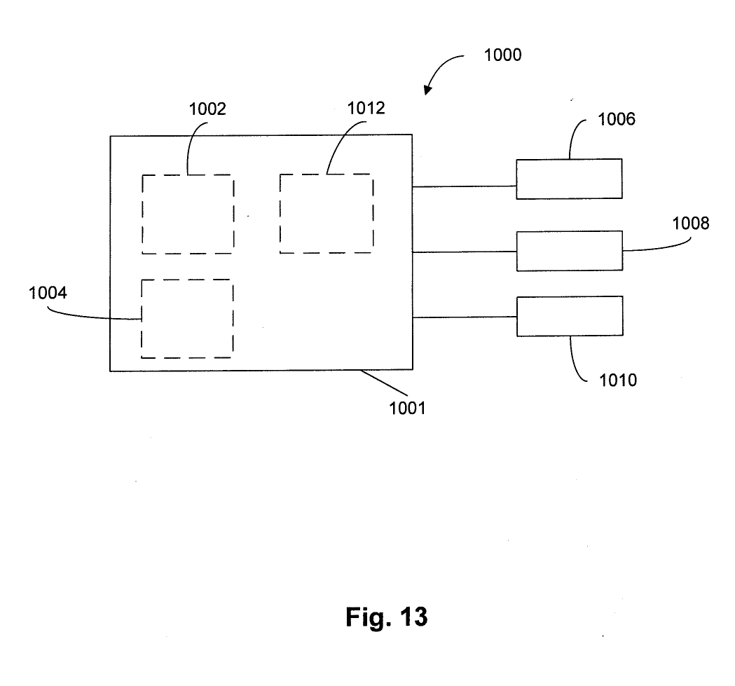

An exemplary system 1000 is shown in FIG. 13 in the form of a computer 1001 with a processing unit 1002 programmed with a rules engine 1004 along with memory 1012 for receiving and storing data. The computer 1001 is in electronic communication with one or more databases 1006 capable of storing the electronic image files to be processed in one or more folders for example. Further, the system 1000 can include one or more input devices 1008, and one or more output devices 1010. The system 1000 is capable of managing data which can be received via the input devices and transmitted via the output devices, controlling program steps, manipulating data, and keeping track of the status of the electronic image files. In particular, the system 1000 is capable of executing various steps and functions of the process described below, at least some of which can be implemented as software. The system is also in communication with other devices such as computer terminals, scanners and/or other Internet access devices, and such communication with other devices is through one or more servers connected to an intranet, the Internet, or both. Suitable processing unit, storage media, scanners and input/output devices are all well-known, readily available devices. Further, one or more computers, servers, and databases can be used.

The system 1000, through the input devices, receives electronic image data files indicative of physical operator logs and stores the electronic image data files in a database or memory. The computer, through the processing unit, executes various program steps to: assign a unique identifier to the electronic image data file; manipulate the electronic image data files to capture and store data regarding operator activity, including converting analog grid information into digital data; manipulate the data regarding operator activity to determine compliance with operator activity standards; and generate at least one report on compliance with operator activity standards. The computer transmits the report on compliance with operator standards to the output devices.

Referring now to FIG. 2, this illustrates process 1, the log scanning process. As shown, at least three alternate flow paths can be used to initialize the paper log sheet scanning process. The paper logs can be physically transferred to a central log processor (CLP), such as by shipping or mailing, or in some cases, electronic images of log sheets (electronic logs) can be electronically sent such as via a facsimile, a .PDF file, or a .tiff file. More particularly, at step 100, the log sheets are sent to a central log processor for scanning, and then processing proceeds to step 101. Otherwise, at step 110, the log sheets can be scanned by a client (such as a driver or a transportation company), or at step 120, the log sheets can be scanned by a third party, such as at a truck stop. After either step 110 or 120, processing proceeds to step 150.

Assuming that it is decided that a central log processor will perform the scanning, at step 101, the logs arrive at a central log processor, such as RAIR Technologies, Inc. The paper log sheets are separated by client name or number at step 103. This separation may be done manually, or may be automated using identifiers on the log sheets. For example, bar code scanners can be used for scanning barcodes on the log sheets which identify a particular form or client. At step 105, the logs are sorted by type or size for scanning, to separate for example, double-sided documents 107A and single-sided documents 107B. Subsequently, at step 109, the paper logs are scanned to produce an electronic image file of each paper log sheet. Preferably, the images resulting from scanning step 109 are .tiff files. The simplex single-sided images 111 are stored in a folder 113 attached electronically to a scanning station. The scanned images in the folder 113 are then packed and compressed at step 115 and a zip package is sent to a processing folder 117. Alternatively, for duplex, double-sided images 119, the images are sent to step 121 at which mending occurs to combine the separate images from both sides of the document into a single image file for each double sided document. In step 125, theses electronic image files are packed and compressed by converting to a zip format and a zip package is sent to processing folder 117.

In the case where the client or a third party scans the paper log sheets, after steps 110 or 120, at step 150, the scanned images are packed into zip format and the resulting zip package is sent to processing folder 117. The electronic images can be accepted from any transmitting location and can even include raw electronic data sent directly from a driver's truck.

As shown in FIG. 3, process 2 involves steps 201-211. At a step 201, a zip-to-.tiff processing engine scans the processing folder 117 for new zip files or packages. Because each zip package is given a package name, such as 5 characters representing a client, 1 character representing a scanning station, and an appended time stamp, step 201 determines whether or not the package has been previously imported by examining the package name. At a step 203, the contents of any newly discovered zip packages are unpacked and a temporary folder is created using the original zip package name. At step 205, each unpacked image record (image file) is added to a data processing database, and processing then proceeds to Process 3a of FIG. 4. For backup purposes, in step 207, the image records are also copied to an image store file, where they are classified by client and date. Next, in step 209, the temporary working folder is deleted. Finally, in step 211, the original zip package or zip files are moved to a zip archive folder for later access if needed.

As shown in FIGS. 4 and 5, processes 3a and 3b include barcode reading, providing unique image file names and loading the image files to document storage. Referring to FIG. 4, at step 301, the processing database sends an image record (image file) to be processed. At step 303, the system queries whether or not the file has a form identification (ID) equal to a predetermined value, such as 99 (undefined). If the form has a form ID of 99, then the process proceeds to step 305, and if the form does not have an ID of 99, then the process proceeds to Process 3b (FIG. 5a).

At step 305, it is determined whether a valid bar code can be found, where a valid barcode indicates a form type. If a valid barcode is found, then the process proceeds to a step 309, and if a valid barcode is not found, then the process proceeds to a step 307. At step 307, the system determines and uses the client's default form and processing proceeds to step 309. At step 309, the image is renamed in the Image Store to indicate a corresponding form type, based on the determined barcode or default form identification. After step 309, at a step 311, the image is also renamed in the database document storage (Doc. Store). After step 311, the images proceed to process 3B as do the images that queried with the form ID not equal to 99 in step 303.

FIG. 5 illustrates the process for loading an image to the Doc. Store. At 313 the processing database sends an image file to step 315, at which the system loads the image to document storage, indicated by the doc store database 317. The load to doc store communicates back and forth with the doc store database 317 to determine if a new subfolder for the client is needed for the image being processed and, if so, retrieves and submits a unique name. This unique image file name is unique across any company. For example, the file name can be generated using a client account number and sequentially generated numbers. In step 319, the file is renamed with the name retrieved in step 315, the file is then moved to personal storage, and the database 317 is updated with the new file name and storage folder. Processing then proceeds to process 4.

FIG. 6 illustrates process 4. As shown in FIG. 6, the image files, which are stored with a unique image file name and path in the database, are next packed and sent for data capture to a data capture center for further processing. For example, the further processing can include extracting (or capturing) the data from the electronic image files. Various data capture centers can be used to allow for distributed processing of these images and quick turnaround times. These data capture centers can be in-house or can be selected outside vendors.

In particular, at 401, the processing database sends image files to a step 403, at which each electronic image file is packed with others and compressed to produce a zip package including for example one hundred (100) image files. At step 405, the system determines an appropriate data capture center to process the images in the zip package by reviewing a form distribution table. The form distribution table can cross-index drivers, carriers and account numbers with an appropriate routing path. Next, in step 407, the zip package of image files is copied to an appropriate data center download folder 419 of an FTP (file transfer protocol) site or server. The FTP site is accessible via the Internet and/or an in-house network and allows the ZIP packages to be uploaded to it, stored in an appropriate subfolder, and later downloaded by the corresponding data capture center.

Additionally, the driver logs database is updated in step 409 to indicate which files are transferred to a data capture center and when they were transferred. The updated database is loaded to the document flow process at step 411. The document flow process populates the client database images, basic information regarding the images, along with document flow, and image table information at step 413. The populated client database is updated to the database in step 415 and the images are reviewed and flagged as outstanding in step 417.

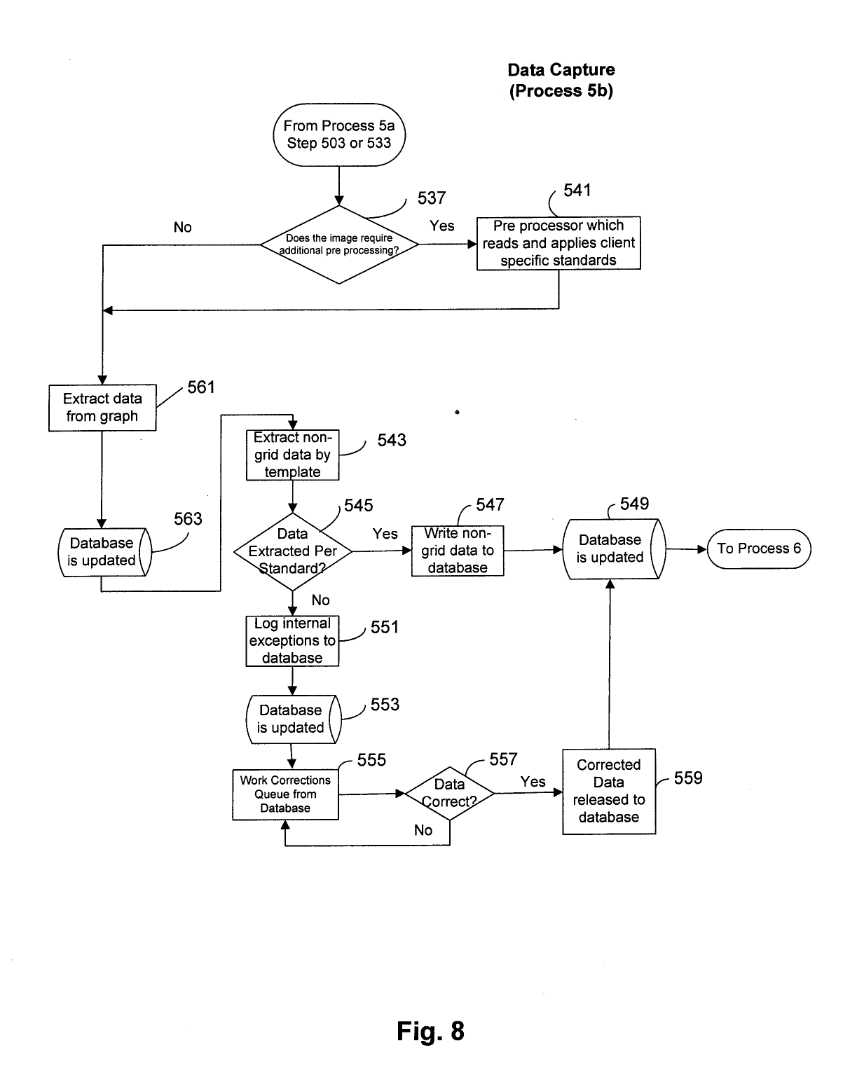

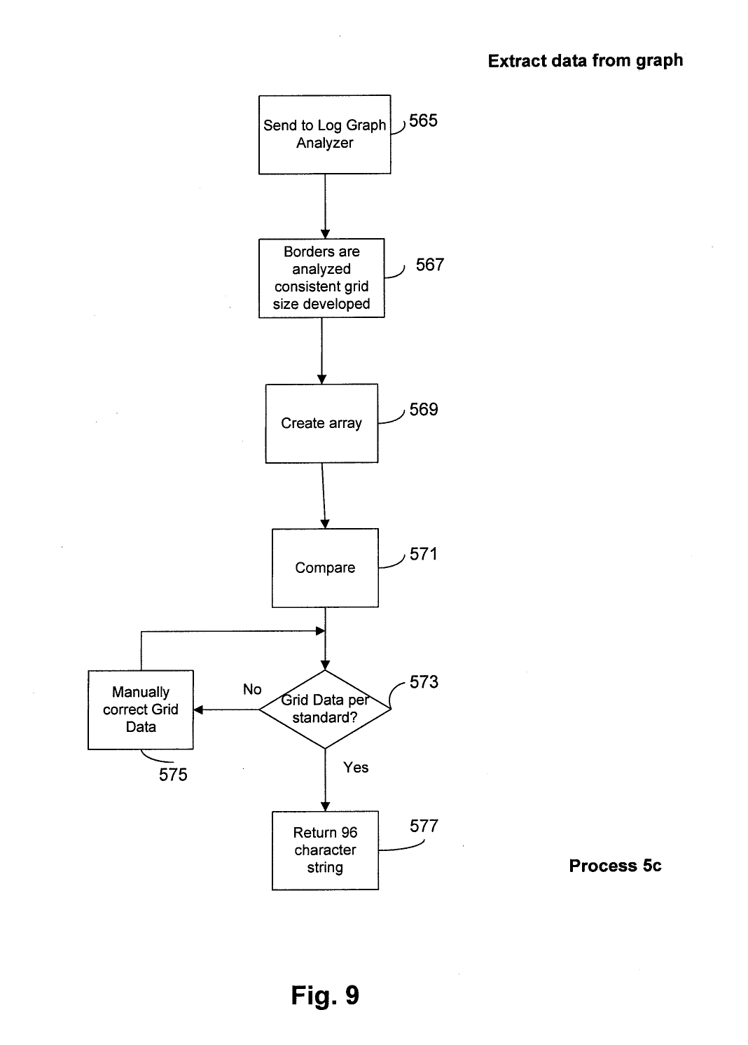

The data capture process can be subdivided into pre-processing and data capture, as illustrated in FIGS. 7 and 8 respectively, with graph capture (i.e., the capture of data regarding reported activity in each of a plurality of time frames on an analog graph) illustrated in FIG. 9. Referring to FIG. 7, a form identification process begins at step 501 at which any packages in the Download Folder of the FTP site are downloaded (by the appropriate data capture center). At step 503, the system queries whether a file has a form identification number associated with it. If the file has a form identification number, then the file is passed through to the data capture process, and specifically, step 537 of FIG. 8 discussed below. If the file is missing a form identification number, then processing proceeds to a step 505. At step 505, the image is rotated, de-skewed and de-speckled. The rotation, de-skewing and de-speckling can be accomplished by any suitable commercially available program, such as Lead Tools, Pegasus, or another built-in module. At step 507, it is determined if the image falls into designated parameters for image size. If so, processing proceeds to a step 511, and, if not, processing proceeds to a step 509. At step 509, the image is adjusted as needed, such as by scaling, so that an appropriate (standard) image size is achieved. Data captured by location requires that the image be a standard size image for analysis. Typically, images within ±25% of the standard template size will fall within the parameters.

Next, at step 511, the form is identified using an optical character recognition (OCR) engine, and cross referencing any recognized contents of the image file with delineated parameters. If the parameters for driver quantification can be determined at a step 513, the system determines the client account number in step 515. The file is then queried to determine if the contents of the file can be read in step 517. If the contents can be read, the file is sent to the driver qualification process at step 521. If the file contents cannot be read, the file must be manually reviewed in step 519. Additionally, if mixed document files are received, manual sorting of these may be necessary.

If the system is unable to determine parameters that either quantify the driver or identify the carrier at step 523, and the log is considered unreadable at 525 and the file is sent for appropriate manual review at step 527.

If parameters identifying the driver log can be identified at step 529, then at step 531, an appropriate carrier account number is determined and associated with the file. Then, in step 533, the system determines if the file contents can be read. If the contents are readable, the file is forwarded to the data capture process of FIG. 8. If the contents are not readable, the file is sent for a manual review at step 535.

Referring to FIG. 8, an exemplary data capture sub-process 5b is illustrated beginning with step 537, at which it is determined whether the image file requires additional preprocessing. For example, clients can have different requirements for how or what portion of their driver logs should be processed and thus some image logs may undergo additional pre-processing. If so, processing proceeds to step 541, and if not, processing proceeds directly to step 561. At step 541, client specific standards regarding pre-processing are applied to the image. Next, subprocess 5b illustrates two separate extraction steps, one for extracting data from the graph (step 561) of the image file, and one for extracting non-grid data (step 543) from the information fields of the image file. Although these are shown as being sequentially performed, these steps can be performed concurrently, or just one or the other of these steps can be performed, depending on a client's particular instructions.

At step 561, data regarding driver activity is extracted from the graph. In this regard, this step is further illustrated in FIG. 9 and discussed in more detail below. After step 561, the database is updated at step 563, and processing proceeds to step 543.

At step 543, a template for a corresponding form of the image file can be applied to extract non-grid data. For example, a template can have identifiers with relationship coordinators to locate the data on the form corresponding to the image file being processed. The template will in essence tell the processor where each information field can be located in the image file and what information is associated with that field.

Further, the system can include image and optical character recognition software which can act to recognize the following: a Social security number or driver identification number and name, a truck/tractor number, a trailer number, a company division, a beginning and ending date (when multiple days are on the same log sheet), a name of a co-driver, total miles driven, the actual driver log graph and a comparison of graphed lines to hours recorded by the driver.

At step 545, the system then determines if the extracted data matches the appropriate standards. For example, the system may validate the extracted data versus a table of possible choices. If the extracted data matches the appropriate standards, then processing proceeds to step 547. If the extracted data does not match the appropriate standards, then processing proceeds to step 551. At step 547, the system writes the non-grid data to the database, and at step 549, the database is updated, and processing proceeds to Process 6, illustrated in FIG. 10. At step 551, the internal exceptions to the standards are logged to the database, and at step 553, the database is updated. Any exceptional logs are sent to a corrections queue at step 555 to be adjusted as necessary, manually if necessary. The adjusted data is analyzed for correctness at step 557, and sent back to step 555 if necessary. If the adjusted data is correct, it is released to the database at step 559, and processing proceeds to step 549 where the database is updated. Again, processing then proceeds to process 6 of FIG. 10.

The graph capture sub-process is shown in FIG. 9 and operates to figure out where the line 9 is on the graph for each 15 minute period, i.e., which activity is being represented by the line for each 15 minute segment. More details regarding one embodiment of this process for extracting data from an analog grid is disclosed in an application entitled “METHOD AND APPARATUS FOR EXTRACTING INFORMATION FROM AN ANALOG GRAPH” filed on the same date as this application, and which is hereby incorporated by reference. In particular, the image files are sent to a log graph analyzer at step 565. The borders of the electronic graph image are analyzed at step 567 and adjusted to achieve a consistent grid size for the image. At step 569, an array of cells is created from the graph portion of the image file by dividing the graph portion into multiple columns, such as 96 columns, each representing a 15 minute portion of the 24-hour time period of the graph, and dividing the graph portion into four rows, each row representing a corresponding activity of the driver, to produce an array of cells with four rows and 96 columns. At step 571, for each column, the analyzer compares the respective amounts of black in each cell to determine which cell has more black, which likely indicates the presence of the line, and determines the activity corresponding to that cell. The result of step 571 is a set of digital values each representing which activity is represented by the line across the entire graph. At step 573, the system then compares the digital values to a predetermined standard to determine if the data is fit for further processing. If not, at step 575 the data is sent for manual correction and then compared again against the standard at step 573. Data meeting the standard is then forwarded at step 577 as a 96-character string to the database.

Referring to FIG. 10, the system reads the captured data as a CSV string in step 601. The system then queries whether an image exists for that CSV string, i.e., to determine whether the image file was already processing. If so, the file is moved to a processed CSV file storage at step 605 and is made available on a website at step 607 for client and reporting purposes. If no image is available, at step 609 the system queries whether the driver is unknown. If the driver is unknown, at step 611 the system queries whether there are any problems associated with the log date or graph data. If these log problems exist, the file is forwarded to data entry queue at step 613. If the log problems do not exist, the file is forwarded to the unknown driver queue at step 615. If the driver is not unknown, then the system queries at step 619 whether there are any problems associated with the log date or the graph data. If such log problems exist, the file is forwarded to the incomplete queue at step 621. If such log problems do not exist, the file is imported at step 623 to the validation process (process 7) shown in FIG. 11. Files from the data entry queue, the unknown driver queue and the incomplete queue can be published to a website to allow for manual correction at step 617 such as by the client, and then the corresponding captured or extracted information for the image files are sent to the validation sub-process shown in FIG. 11.

Referring to FIG. 11, the validation process begins at step 702 by checking the extracted data for form and manner violations. For example, the total hours of each activity as determined by graph extraction and further processing of this data can be checked against the total hours of activity filled in by the driver on the form to determine whether the totals match. Next, the system checks at step 703 for hours of service violations, i.e., to check if a driver has been working and/or driving too long. Next, the logs are verified for accuracy in step 705 according to a client's instructions. A variety of accuracy verifications can be performed using perhaps other supplied client information such as fuel receipts, meal reimbursement forms, inspections, GPS data, to see if the information from the log sheet matches the other client information. The system then checks at step 707 for team violations that may exist between a driver and a co-driver. This entails correlating extracted data associated with different electronic image files. Processing then proceeds to step 605 of FIG. 10, at which the validated files are moved to CSV storage and are available on the website for review by a carrier.

All of the data that has been assembled can be reported using standard and client-specified reporting formats. Summary reports of all data can be available online at all times. More specifically, some of the reports that can be generated include: identification of missing logs for a specific time period, summary reports including any violations of Federal or company policy including speed violations, violations of hour and day work rules, summary reports indicating miles driven, hours worked, average speed and average distance; comparisons of driver log summary data for 24 hour and 7 day (or 8 day) rule with the actual log graph and a summary of the indicated errors; comparisons of miles driven against actual driving time as recorded in the log to ensure that mileage appears to be accurate; company totals for all drivers indicating percentage of compliance over a given time period; reports of vehicle utilization records (hours utilized by specific vehicle for a given time period); and team driver interactions.

The method is preferably performed by means of one or more interconnected computers, such as local computers or servers communicating through the Internet to central operations and central processing sites. The driver log management method described herein represents a significant improvement over prior art methods currently available in that the log maintenance process is automated. This automatic process is beneficial because a carrier's internal resources and costs associated with driver logs can be drastically reduced. Further, it is not necessary for a carrier's personnel to be involved in the auditing process and requires merely that the required driver logs be provided to a central log processor. A carrier need not physically maintain any paper records, because the driver log image files maintained electronically and is accessible at all times from any computer with an Internet connection. Document images can be securely stored.

It is specifically intended that the present invention not be limited to the embodiments and illustrations contained herein, but include modified forms of those embodiments including portions of the embodiments and combinations of elements of different embodiments as come within the scope of the following claims.

What is claimed is:

1. A data processing system for managing driver log sheets, the system comprising:
a scanner for converting physical driver log sheets into electronic image files, wherein each driver log sheet corresponds to a respective one of the electronic image files;
one or more computers each having a processor and a database for storing data, for receiving the electronic image files and operating to associate a unique identifier to each electronic image file, process each electronic image file to capture data regarding reported activity in each of a plurality of time frames of an analog graph and produce a reported activity data file, process the reported activity data file for each electronic image to determine compliance with activity standards, and generate a report on the compliance with activity standards.

2. The data processing system of claim 1, further including one or more data processing centers for distributed processing of the electronic image files to capture data regarding reported activity which is then reported back to the one or more computers as respective reported activity data files.

3. The data processing system of claim 1, wherein the one or more computers also extract, for each electronic image file, non-graph data from each of a plurality of information fields with filled in characters.

4. A method performed by a computer for managing driver log sheets for reporting driver time, the method comprising:
scanning the physical driver log sheets, each driver log sheet including an analog graph with reported driver activity for each of a plurality of time periods, to obtain electronic image files, wherein each driver log sheet corresponds to a respective one of the electronic image files;
storing the electronic image files on a storage medium;
associating a unique identifier to each electronic image file;
processing the electronic image files to extract from each file respective captured graph data indicative of reported driver activity for each of the time periods,
processing the captured graph data indicative of reported driver activity to determine compliance with driver activity standards; and
generating a report on compliance with driver activity standards.

5. The method of claim 4, wherein the driver log sheets include different size documents or different format documents.

6. The method of claim 4, wherein the captured graph data is analyzed for form and manner violations.

7. The method of claim 4, wherein the captured graph data is checked for hours of service violations.

8. The method of claim 4, wherein the captured graph data is checked for team violations.

9. The method of claim 4, wherein the generated report provides the overall compliance from a group of driver log sheets.

10. The method of claim 9, wherein the group of driver log sheets represent the activity of multiple operators.

11. The method of claim 9, wherein the group of driver log sheets represent the activity of a single operator.

12. The method of claim 9, wherein the generated report provides notice of systematic or severe non-compliance with activity standards.

13. A method performed by a computer for managing driver log sheets for reporting driver time, the method comprising:
scanning physical driver log sheets, each including filled in characters in information fields and an analog graph with reported driver activity for each of a plurality of time periods, to obtain electronic image files, wherein each driver log sheet corresponds to a respective one of the electronic image files;
storing the electronic image files on a storage medium;
associating a unique identifier to each electronic image file;
processing the electronic image files to extract from each file respective captured graph data indicative of reported driver activity for each of the time periods and respective non-graph data indicative of filled in characters;
processing the captured graph data regarding reported driver activity to determine compliance with driver activity standards; and
generating a report on compliance with driver activity standards.
